(19) United States
(12) Patent Application Publication
(10) Pub. No.: US 2005/0002181 A1
(43) Pub. Date: Jan. 6, 2005

(54) Illuminated cosmetic case structure

(76) Inventors: Mark Chernick, Woodinville, WA (US); Webb Nelson, Woodinville, WA (US)

Correspondence Address: Eric A. LaMorte;LaMorte & Associates, P.C., P.O. Box 434, Yardley, PA, 19067, US

(21) Appl. No.: 10/610,576

(22) Filed: Jul. 2, 2003

(51) Int. Cl. F21V 33/00; A45C 15/06

(52) U.S. Cl. 362/136

(57) ABSTRACT

An internally illuminated cosmetic case that enables the color of the cosmetic material inside the case to be observed through the structure of the cosmetic case. A housing is provided that defines an internal chamber. The housing is made of a translucent or transparent material that enables the internal chamber to be observed through the structure of the housing. A volume of cosmetic material is disposed within the internal chamber. A light source is provided that shines light into the structure of the housing and illuminates the internal chamber within the housing. In this manner the color of the cosmetic material in the housing can be perceiveded.

### BACKGROUND OF THE INVENTION

1. Field of the Invention

The present invention is related to illuminated cosmetic cases that illuminate and provide light for the application of the cosmetic during low light conditions.

2. Prior Art Statement

A conventional cosmetic case is used to hold cosmetics. Such cosmetic cases typically lack any other function. Cosmetics are typically applied in a well illuminated room while looking into a mirror. However, many women commonly reapply cosmetics at various times. Often a well illuminated space with a mirror is unavailable. When applying cosmetics in a dim place, it is hard for a user to neatly apply the cosmetic without mistake.

In order to apply a cosmetic in a dimly lit place, a user needs to carry an illuminated cosmetic case. Over the years there have been many types of illuminated cosmetic cases that contain their own sources of illumination. Most of these prior art cosmetic cases contain lights inside the case. The lights automatically illuminate when the cosmetic case is opened. Such illuminated cases also typically come with small mirrors. The lights are oriented so that a 5 person looking into the small mirror will have their face illuminated. As soon as the cosmetic case is closed, the light turns off.

Many women own many different cosmetic cases to hold many different types and colors of cosmetics. These cosmetic cases tend to accumulate in bathroom drawers, purses and other poorly illuminated areas. As such, a woman must rummage through many different cosmetic cases trying to find the one she wants. Furthermore, many cosmetics differ only slightly in color. Many times a woman must open the cosmetic case in good lighting just to identify the color of the cosmetic found within the cosmetic case.

The present invention is an illuminated cosmetic case where the body of the cosmetic case is both translucent and internally illuminated. In this manner, the cosmetic case illuminates the contents of the cosmetic case as well as any surface adjacent the cosmetic case. The cosmetic case can be internally illuminated while still closed. As such, the cosmetic case and its contents can be easily identified within a purse or other dark area without having to open the cosmetic case.

The present invention cosmetic case is described and claimed below.

### SUMMARY OF THE INVENTION

The present invention is an internally illuminated cosmetic case that enables the color of the cosmetic material in the case to be observed through the structure of the cosmetic case. A housing is provided that defines an internal chamber. The housing is selectively configurable between a closed condition, where the internal chamber is isolated, and an open condition, where the internal chamber is accessible. The housing is made of a translucent or transparent material that enables the internal chamber to be observed through the structure of the housing.

A volume of cosmetic material is disposed within the internal chamber. Furthermore, a light source is provided that shines light into the structure of the housing and illuminates the internal chamber within the housing. By illuminating the internal chamber in the housing, the color of the cosmetic material in the internal chamber can be ascertained by looking through the structure of the housing.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of the present invention cosmetic case;

FIG. 2 is a cross-sectional view of the cosmetic case of FIG. 1; and

FIG. 3 is a schematic of the electronic assembly contained within the exemplary embodiment of the cosmetic case.

### DETAILED DESCRIPTION OF THE DRAWINGS

Although the present invention cosmetic case can be used to hold many different types of cosmetics, such as blush, lipstick and the like, the illustrated embodiment of the cosmetic case is one that holds a volume of eye shadow. Such an embodiment is merely exemplary and should not be considered a limitation of the scope of the invention. Cosmetic casing for other types of cosmetics have other traditional shapes. It will be understood that the present invention can be applied to any such cosmetic case, regardless of the type of cosmetic being retained.

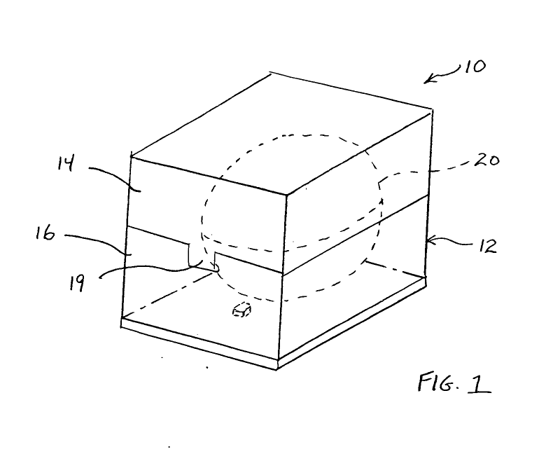

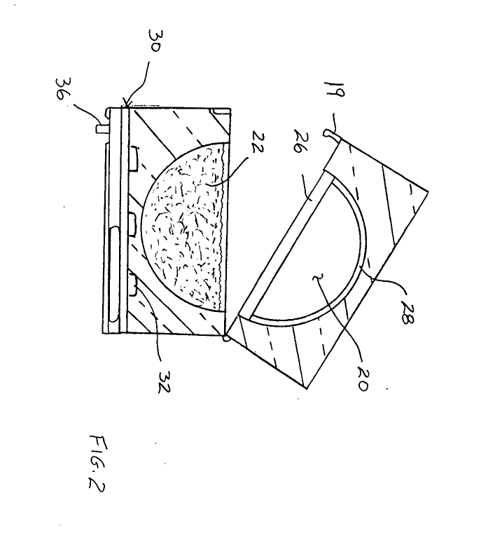

Referring to both FIG. 1 and FIG. 2, an exemplary embodiment of a cosmetic case 10 is shown for holding a volume of compacted eyeshadow powder. The cosmetic case 10 has a housing that is made of a translucent or transparent material, such as glass or plastic. The housing 12 of the cosmetic case 10 is divided into a lid section 14 and a base section 16. The lid section 14 and the base section 16 of the housing 12 are hinged so that the housing 12 can be selectively opened and closed. A latch 19 is provided to prevent the housing 12 from opening inadvertently.

In the shown embodiment, the housing 12 of the cosmetic case 10 has a cubic shape where the lid section 14 and base section 16 are generally equal in proportion. However, it will be understood that in alternate embodiments, the shape of the housing 12 can be altered to any shape and the lid section 14 can be made much thicker or thinner than the base section 16.

The housing 12 of the cosmetic container 10 defines an internal chamber 20. The exterior of the internal chamber 20 can be viewed through the housing 12 because of the transparent/translucent construction of the housing 12. Referring now solely to FIG. 2, it can be seen that the internal chamber 20 extends into both the lid section 14 and the base section 16 of the housing 12. The internal chamber 20 in the base section 16 of the housing 12 is filled with a volume of cosmetic material 22. The cosmetic material 22 has a premanufactured color. The color of the cosmetic material 22 is observable through the transparent/translucent housing 12 since there is no opaque barrier between the colored cosmetic material 22 and the exterior of the housing 12. As such, it will be understood that a person can perceive the color of the cosmetic material 22 in the cosmetic case 10 just by observing the exterior of the cosmetic case 10.

In the shown embodiment, the internal chamber 20 also extends into the top section 14 of the housing 12. The internal chamber 20 in the top section 14 of housing 12 can also be filled with cosmetic material. In such a case, the cosmetic case 10 would be symmetrically formed with no set top and no set bottom. However, in the shown embodiment, a mirror 26 is disposed in the internal chamber 20 of the top section 14 of the housing 12. In this manner, when the cosmetic case 10 is opened, one half of the housing 12 holds the cosmetic material 22, while the other half of the housing 12 holds a small mirror 26 that can be used in the application of the cosmetic material 22.

Since the housing 12 is transparent or translucent and the mirror 26 is opaque, the mirror 26 prevents the cosmetic material 22 from being directly observed through the top of the housing 12. To assist in color identification and to improve the overall aesthetics of the cosmetic case 10, the internal chamber 20 in the top section 14 of the housing is coated with a pigment layer 28 that has the same color as the cosmetic material 22. The pigment layer 28 is opaque and prevents the back of the mirror 26 from being observed. Accordingly, the color of the cosmetic material 22 contained within the cosmetic case 10 can be determined by either viewing the cosmetic material 22 directly through the bottom section 16 of the housing 12 or viewing the pigment layer 28 through the top section 14 of the housing 12.

It will be understood that if desired for manufacturing efficiency, the internal chamber 20 in the bottom section 16 of the housing 12 can also be internally coated with a layer of pigment. In such a manufacturing process, the cosmetic material 22 itself would not be directly observed through the housing 12. Rather, the layer of pigment that is indicative of the color of the cosmetic material would be observed. In this manner, the color of the cosmetic material 22 can be easily perceived even if there is very little of the cosmetic material 22 left within the cosmetic case 10.

Although the color of the cosmetic material 22 within the cosmetic case can be observed by viewing the internal chamber through the translucent/transparent housing 12 of the cosmetic case 10, light is still needed to properly ascertain the color. Light is provided to the cosmetic case 10 using an electronic assembly 30 at the bottom of the housing 12. The electronic assembly 30 includes at least one light emitting diode (LED) 32 that directs light directly into the translucent/transparent material of the housing 12. Since the light from the LED(s) shines into the material of the housing 12, the housing 12 becomes internally illuminated. Reflected and refracted light from the LED(s) 32 shines from every external surface of the translucent/transparent material of the housing 12, thereby making the housing 12 glow with light. The light passing through the translucent/transparent material of the housing 12 also brightly illuminates the contents of the internal chamber 20 defined within the housing 12. As has been explained, the internal chamber 20 expresses the color of the cosmetic material 22 contained therein. Consequently, the color of the cosmetic material 22 can be easily ascertained.

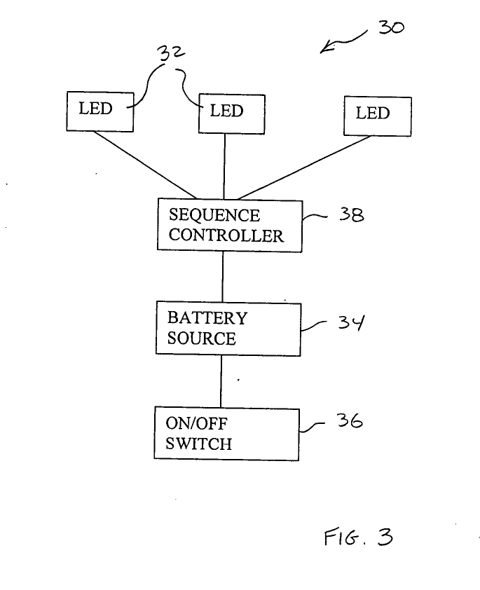

Referring to FIG. 3, it can be seen that the electronic assembly 30 that internally illuminates the housing of the cosmetic case contains at least one LED 32 and preferably more than one LED 32. If more than one LED 32 is used, the LEDs 32 need not be of the same color, but rather may be of different colors. The LEDs 32 can be of traditional construction. However, in the embodiment of FIG. 1 and FIG. 2, the LEDs 32 are solid state LEDs that are mounted on a circuit board. Solid state LEDs are small and take up very little room.

From FIG. 3, it can be seen that the LEDs 32 are powered by a battery source 34. In a preferred embodiment, the battery source 34 is at least one flat battery that minimizes the mount of area needed to retain the batteries in the cosmetic case. The powering of the LED(s) 32 by the battery source 34 is controlled by an on/off switch 36. The on/off switch 36 can be a simple push button or pull tab switch. However, the on/off switch 36 can also be a motion sensor switch that activates the LED(s) each time the cosmetic case is shaken. Other types of on/off switches that can be used, include, but are not limited to, touch sensitive switches, reed switches, photodetector switches and orientation switches.

If one LED 32 is used, the on/off switch 36 simply connects the battery source 34 to the LED 32 when activated. However, if multiple LEDs 32 are used, a sequence controller 38 can be added. The sequence controller 38 activates and deactivates the various LEDs 32 depending upon different preprogrammed operational modes. For example, if three different colored LEDs 32 are provided, multiple different 5 operational modes can be obtained. In a first mode, only one color LED may be lit. In subsequent modes, other LEDs and combinations of LEDs can be lit to produce a wide variety of different colors. In still other operational modes, the various LEDs can be caused to activate and deactivate at different times so that the light produced by the LEDs changes over time. The selection of the operational mode can be controlled through the on/off switch 36. If the on/off switch 36 is activated once, a first operational mode starts. If the on/off switch 36 is activated twice, a second operational mode starts, and so on.

Returning now to FIG. 2, it will be understood that to utilize the present invention cosmetic case 10, a person activates the on/off switch 36 within the electronic assembly 30. Once activated, the LED(s) 32 activate in some preprogrammed operational sequence. The light from the LED(s) 32 internally illuminates the housing 12 of the cosmetic case 10 and illuminates the internal chamber 20. The color of the cosmetic material 22 in the internal chamber 20 is ascertained through the material of the housing 12 without having to open the housing 12.

The opening of the housing 12 of the cosmetic S case 10 has no effect upon the LED(s) 32. Rather, the LED(s) 32 continue to light in the operational mode sequence. As such, when a person opens the cosmetic case 10 and is using the cosmetic material 22 contained within, the housing 12 of the cosmetic case 10 remains internally illuminated. The light from the illuminated housing 12 illuminates the user's face and helps in the proper application of the cosmetic material 22 to the face by illuminating the user's face near the cosmetic case 10. Once the cosmetic material 22 is applied, the cosmetic case 10 is closed and the LED(s) can be deactivated.

It will be understood that the embodiment of the present invention cosmetic case 10 described and illustrated is merely exemplary and a person skilled in the art can make many variations to the shown embodiment. For example, in the illustrated embodiment, the cosmetic case is cubic with a spherical internal chamber. The shape of the exterior of the cosmetic case and the internal chamber are irrelevant to the invention and can be changed to any desired shape. All such alternate embodiments and modifications are intended to be included within the scope of the present invention as defined below in the claims.

1. An illuminated cosmetic case assembly, comprising;
a housing defining an internal chamber, said housing being selectively configurable between a closed condition, where said internal chamber is isolated in said housing, and an open condition, where said internal chamber is accessible, wherein said housing is transparent and said internal chamber can be observed through said housing;
a volume of cosmetic material disposed within said internal chamber; and
a light source that shines light into said housing for illuminating said internal chamber within said housing.

2. The assembly according to claim 1, wherein said cosmetic material has a color and said color is observable through said housing.

3. The assembly according to claim 1, wherein said cosmetic material has a color and at least a portion of said internal chamber is coated with a pigment layer of said color, wherein said pigment layer is observable through said housing.

4. The assembly according to claim 1, further including a mirror disposed in said internal chamber.

5. The assembly according to claim 1, further including an activation switch for activating said light source while said housing is in said closed condition.

6. The assembly according to claim 5, wherein said activation switch is selected from a group consisting of button switches, lever switches, touch activated switches, vibration activated switches, light sensitive switches and reed switches.

7. The assembly according to claim 1, wherein said light source contains a light emitting diode.

8. The assembly according to claim 1, wherein said light source includes a plurality of light emitting diodes.

9. The assembly according to claim 8, further including a sequence controller for selectively activating said light emitting diodes in at least one preprogrammed sequence.

10. The assembly according to claim 8, wherein each of said plurality of light emitting diodes emits light of a different color.

11. A method of illuminating the contents of a cosmetic case, comprising the steps of:
providing a housing made of translucent material, wherein said housing defines an internal chamber that is observable through said translucent material;
placing a volume of colored cosmetic material within said internal chamber;
providing a light source within said housing for internally illuminating said housing so that said internal chamber is illuminated within said housing.

12. The method according to claim 11, further including the step of coating at least a portion of said internal chamber with a pigment layer that is the same color as said cosmetic material, wherein said pigment layer is illuminated by said light source and is observable through said translucent material.

13. The method according to claim 12, further including the step of providing a mirror within said housing wherein said pigment layer prevents said mirror from being observed through said translucent material while said housing is closed.

14. The method according to claim 11, wherein said step of providing a light source includes providing at least one light emitting diode that emits light into said translucent material.

15. The method according to claim 14, wherein said step of providing a light source includes providing a plurality of light emitting diodes that emit light into said translucent material, wherein each of said light emitting diodes emits a different colored light.

16. The method according to claim 15, further including the step of lighting said light emitting diodes in a preprogrammed sequence.

17. The method according to claim 11, further including the step of providing an activation device for selectively activating and deactivating said light source.
